(19) United States
(12) Patent Application Publication
(10) Pub. No.: US 2003/0197831 A1
(43) Pub. Date: Oct. 23, 2003

(54) Lens fastening device for frameless spectacles

(76) Inventor: Hyoung Sik Kim, Seoul (KR)

Correspondence Address: John S. Egbert, Harrison & Egbert, 7th Floor, 412 Main Street, Houston, TX, 77002, US

(21) Appl. No.: 10/127,002

(22) Filed: Apr. 12, 2002

(51) Int. Cl. G02C 1/02; G02C 5/00

(52) U.S. Cl. 351/140

(57) ABSTRACT

Disclosed is a lens fastening device for frameless spectacles. The lens fastening device comprises a first fastening element made of soft synthetic resin, possessing a guide part formed at a lower end thereof, defined with a threaded hole and having a tapered part to be decreased in its diameter toward an upper end thereof, and a second fastening element prepared separately from and coupled to the first fastening element, made of metal or hard synthetic resin, possessing a flange part formed on an outer surface and at an upper end thereof, defined with a threaded groove and an engagement groove into which the guide part of the first fastening element is engaged, and having a body part.

### RELATED U.S. APPLICATIONS

Not applicable.

### STATEMENT REGARDING FEDERALLY SPONSORED RESEARCH OR DEVELOPMENT

Not applicable.

### REFERENCE TO MICROFICHE APPENDIX

Not applicable.

### FIELD OF THE INVENTION

The present invention relates to a lens fastening device for frameless spectacles, used for fastening a lens to each of a bridge and an arm, and more particularly, the present invention relates to a lens fastening device for frameless spectacles, which is modified in its construction to accomplish improvement over an integrally molded lens fastening device for frameless spectacles as described in Korean Utility Model Application No. 2001-4644 filed in the name of the present applicant, in that it is divided into two fastening elements made of different materials and coupled with each other in such a way as to provide strong fastening force thereby to prevent a screw passing through a lens and each of a bridge and an arm from being unintentionally unthreaded.

### BACKGROUND OF THE INVENTION

These days, in order to meet a variety of customers' tastes, in addition to framed spectacles, frameless spectacles rendering an aesthetic appeal have been widely used throughout the world. The relevant patents of the spectacles are disclosed in U.S. Pat. Nos. 2,071,045, 2,175,355, 2,450,694, 3,030,997, 3,040,796, 3,522,830, 4,887,950, and 5,627,610, and Japanese Patent Laid-open Publication Nos. Heisei. 11-212031 and 12-281788.

In such frameless spectacles, a pair of lenses each having an appropriate curvature depending upon a power thereof are connected with each other by a bridge, and an arm having a hooked portion, which is put around the ear of a wearer, is hingedly joined to each lens at a place which is opposite to a point where the lens is fastened to the bridge.

At this time, the lens is fastened to each of the bridge and arm by a lens fastening mechanism. The lens fastening mechanism comprises a screw simultaneously passing through holes which are respectively defined in the lens and each of the bridge and arm; a sleeve washer made of soft plastic and partially fitted from an inner surface of the lens into the hole defined in the lens in such a way as to allow the screw to be inserted therethrough and eliminate a gap between the lens and screw, thereby to prevent the lens from being fluctuated and the screw from being unintentionally unthreaded; a nut tightened on a portion of the screw, which portion is exposed out of the sleeve washer, to squeeze the lens against each of the bridge and arm; and a safety cap made of plastic and covering an end of the screw, which end is exposed out of the nut, to protect the skin of the wearer from being damaged by the end of the screw.

The conventional lens fastening mechanism constructed as mentioned above suffers from defects in that, since it is composed of a plurality of component elements, an assembling procedure is made complicated and productivity is deteriorated. Also, because each of the component elements which constitute the lens fastening mechanism has a small size, it is difficult to handle those component elements, and the possibility of the component elements to be lost is increased. Further, due to the fact that the number of component elements is increased and each component element has a small size, a manufacturing cost of the lens fastening mechanism cannot but be raised.

To cope with these defects, the present applicant disclosed a lens fastening device for frameless spectacles in Korean Utility Model Application No. 2001-4644. This lens fastening device comprises a fastening body made of synthetic resin. A guide part, which is to be inserted into a hole defined in a lens, is integrally formed at an end of the fastening body. A flange part for squeezing the lens against each of a bridge and an arm is formed around a middle portion of the fastening body. The fastening body is defined with a threaded groove into which a screw for fastening the lens to each of the bridge and arm is threadedly coupled. Therefore, it is possible to securely fasten the lens to each of the bridge and arm, using the fastening body and the screw. As a consequence, as the number of component elements is decreased, productivity is improved and a manufacturing cost is reduced, while fastening force is elevated to prevent the screw from being unintentionally unthreaded.

However, the above described conventional lens fastening device for frameless spectacles has a drawback in that the fastening body is formed by molding only one of soft and hard synthetic resin. Concretely speaking, in the case that the fastening body is made of soft synthetic resin, while advantages of improved cushioning are provided and a gap between the lens and the screw is eliminated to prevent the lens from being fluctuated and the screw from being unintentionally unthreaded, there is a disadvantage that, in a portion of the fastening body which portion is exposed out of an inner surf ace of the lens to serve as a nut, an internal thread of the fastening body is liable to be crushed by threading force of the screw, and thereby the fastening body cannot properly perform a function of the nut.

On the contrary, in the case that the fastening body is made of hard synthetic resin, while the internal thread of the fastening body is not crushed and the fastening body itself is not bulged outward by threading force of the screw, the probability of a gap to be defined between the lens and the screw is increased. Thereby, the lens is likely to be fluctuated, and it is difficult to provide strong fastening force.

Further, in the conventional lens fastening device for frameless spectacles, while the fastening body is formed by molding only one of soft and hard synthetic resin as described above, the synthetic resin has inherent limitations in that it is apt to be excessively softened in the summer and excessively hardened in the winter. By this fact, as the excessive softening and hardening of the synthetic resin are repeated with the lapse of time, the screw can be loosened in the fastening body, and thereby, the likelihood of the lens to be fluctuated with respect to each of the bridge and arm is further increased.

### BRIEF SUMMARY OF THE INVENTION

Accordingly, the present invention has been made in an effort to solve the problems occurring in the related art, and an object of the present invention is to provide a lens fastening device for frameless spectacles, which is modified in its construction to accomplish improvement over the integrally molded lens fastening device for frameless spectacles as described in Korean Utility Model Application No. 2001-4644 filed in the name of the present applicant, in that it is divided into two fastening elements coupled with each other in a one-touch manner, a first fastening element inserted in a hole defined in a lens is made of soft synthetic resin so as to eliminate a gap between the lens and a screw threaded through the first fastening element, and a second fastening element is made of hard synthetic resin or metal so as not to be bulged outward by threading force of the screw thereby to provide strong fastening force.

Another object of the present invention is to provide a lens fastening device for frameless spectacles, in which a fastening element inserted in a hole defined in a lens has a predetermined taper to permit easy fitting thereof.

In order to achieve the above objects, according to one aspect of the present invention, there is provided a lens fastening device for frameless spectacles, comprising: a first fastening element made of soft synthetic resin, possessing a guide part formed at a lower end thereof, defined with a threaded hole, and having a tapered part to be decreased in its diameter toward an upper end thereof, and a second fastening element prepared separately from and coupled to the first fastening element, made of metal or hard synthetic resin, possessing a flange part formed on an outer surface and at an upper end thereof, defined with a threaded groove and an engagement groove into which the guide part of the first fastening element is engaged, and having a body part.

According to another aspect of the present invention, an insertion groove having an inner diameter, which is the same as an outer diameter of the guide part, is defined on an inner surface defining the threaded groove and adjacent to the upper end of the second fastening element; the engagement groove is defined on another inner surface defining the insertion groove; and an engagement projection is formed on an outer surface of the guide part of the first fastening element, whereby the guide part is inserted into the insertion groove and the engagement projection is engaged into the engagement groove.

According to still another aspect of the present invention, there is provided a lens fastening device for frameless spectacles, comprising: a fastening element having a guide part and a body part which are integrally formed with each other, the guide part being inserted into a hole which is defined through a lens, the body part being defined on an outer surface thereof with a circumferential fitting groove; and a flange element fitted into the circumferential fitting groove and made of metal or hard synthetic resin.

### BRIEF DESCRIPTION OF THE SEVERAL VIEWS OF THE DRAWINGS

The above objects, and other features and advantages of the present invention will become more apparent after a reading of the following detailed description when taken in conjunction with the drawings, in which:

FIG. 1 is an exploded perspective view illustrating a lens fastening device for frameless spectacles in accordance with a first embodiment of the present invention.

FIG. 2 is a cross-sectional view illustrating an assembled status of the lens fastening device of FIG. 1.

FIG. 3 is a partially enlarged cross-sectional view illustrating a state wherein each lens is fastened by the lens fastening device of FIG. 1; and

FIG. 4 is a cross-sectional view illustrating a lens fastening device for frameless spectacles in accordance with a second embodiment of the present invention.

### DETAILED DESCRIPTION OF THE INVENTION

Reference will now be made in greater detail to a preferred embodiment of the invention, an example of which is illustrated in the accompanying drawings. Wherever possible, the same reference numerals will be used throughout the drawings and the description to refer to the same or like parts.

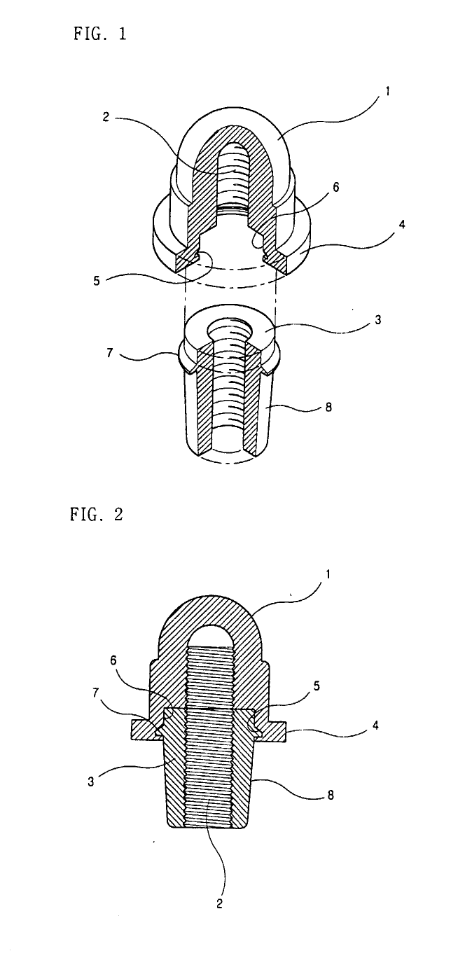

FIG. 1 is an exploded perspective view illustrating a lens fastening device for frameless spectacles in accordance with a first embodiment of the present invention; and FIG. 2 is a cross-sectional view illustrating an assembled status of the lens fastening device of FIG. 1.

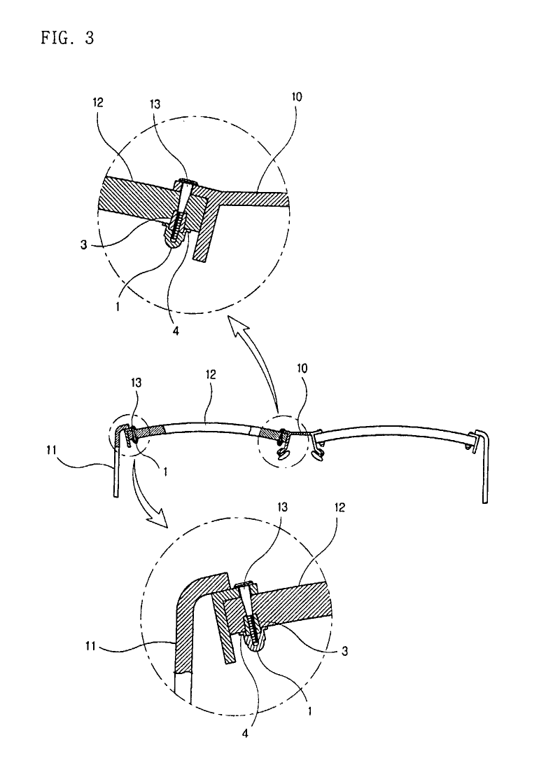

A lens fastening device according to this embodiment of the present invention comprises a fastening element and a second fastening element. The first fastening element is made of soft synthetic resin, and possesses a guide part 3 and a tapered part 8. The guide part 3 is formed at a lower end of the first fastening element when viewed on a plane of FIG. 3. The tapered part 8 is decreased in its diameter toward an upper end of the first fastening element to have substantially a truncated cone-shaped outer contour. The first fastening element is defined with a threaded hole. The second fastening element is prepared separately from and coupled to the first fastening element. The second fastening element is made of metal or hard synthetic resin, and possesses a flange part 4 and a body part.

The flange part 4 is formed on an outer surface and at an upper end of the second fastening element. The second fastening element is defined with a threaded groove 2 and an engagement groove 5 into which the guide part 3 of the first fastening element is engaged.

An insertion groove 6 having an inner diameter, which is the same as an outer diameter of the guide part 3, is defined on an inner surface defining the threaded groove 2 and adjacent to the upper end of the second fastening element. The engagement groove 5 is defined on another inner surface which defines the insertion groove 6. An engagement projection 7 is formed on an outer surface of the guide part 3 of the first fastening element. The guide part 3 is inserted into the insertion groove 6, and the engagement projection 7 is engaged into the engagement groove 5.

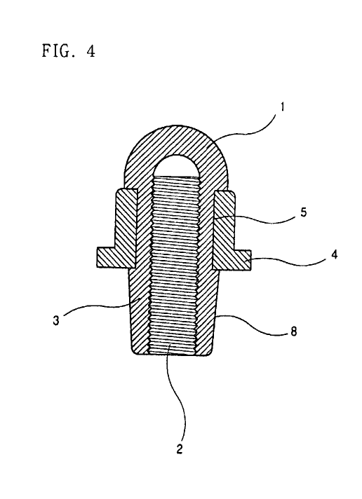

FIG. 4 is a cross-sectional view illustrating a lens fastening device for frameless spectacles in accordance with a second embodiment of the present invention.

The lens fastening device according to this second embodiment of the present invention comprises a fastening element and a flange element 4. The fastening element has a guide part 3 and a body part 1 which are integrally formed with each other. The guide part 3 is inserted into a hole which is defined through a lens, and the body part 1 is defined on an outer surface thereof with a circumferential fitting groove 5. The flange element 4 is fitted into the circumferential fitting groove 5 and is made of metal or hard synthetic resin.

In FIG. 3, the unexplained reference numeral 10 designates a bridge, 11 an arm, 12 a lens, and 13 a fastening screw.

Hereafter, operation of the lens fastening devices according to the present invention constructed as mentioned above will be described in detail.

First, in the lens fastening device according to the first embodiment of the present invention as shown in FIGS. 1 through 3, the first fastening element having the guide part 3 and the second fastening element having the body part 1 are prepared separately from each other and coupled with each other. As described above, the first fastening element is made of soft synthetic resin, and the second fastening element is made of metal or hard synthetic resin. Adjacent to an upper end of the threaded groove 2, the insertion groove 6 and the engagement groove 5 are defined on the inner surface of the second fastening element.

Consequently, as the guide part 3 and the engagement projection 7 are inserted and engaged into the insertion groove 6 and the engagement groove 5, respectively, in a one-touch manner, an assembling procedure of the lens fastening device according to this first embodiment of the present invention is completed. The lens fastening device assembled in this way can firmly and easily fasten the lens 12 to each of the bridge 10 and the arm 11.

As in the conventional art, a pair of lenses 12 are connected with each other by the bridge 10. At this time, fastening holes are defined in the bridge 10, arm 11 and lens 12. Therefore, in a state wherein the fastening holes defined in the lens 12 and each of the bridge 10 and the arm 11 are aligned with each other, the tapered part 8 of the first fastening element is fitted into the fastening hole defined in the lens 12. By this fact, the flange part 4 of the second fastening element is brought into contact with an inner surface of the lens 12 around the fastening hole to squeeze the lens 12 against each of the bridge 10 and the arm 11 thereby to provide strong fastening force.

After the tapered part 8 of the first fastening element is fitted into the fastening hole defined in the lens 12 in a state wherein the second fastening element is coupled to the first fastening element, as can be readily seen from FIG. 3, the fastening screw 13 is inserted into the fastening holes defined in the lens 12 and each of the bridge 10 and the arm 11. Then, the fastening screw 13 is threaded through the threaded hole of the first fastening element into the threaded groove 2 of the second fastening element. At this time, due to the fact that the threaded groove 2 has an inner diameter which is smaller than an outer diameter of the fastening screw 13, if the fastening screw 13 is fully tightened into the threaded groove 2, as outer diameters of the first and second fastening elements are slightly increased, the lens 12 can be reliably and securely fastened to each of the bridge 10 and the arm 11.

Also, in the lens fastening device, since the guide part 3 of the first fastening element made of soft synthetic resin is positioned in the flange part 4 of the second fastening element made of metal or hard synthetic resin scarcely influenced by a weather condition, even in the case that the guide part 3 is softened and hardened due to temperature changes, fastening force is not diminished between the lens 12 and each of the bridge 10 and the arm 11, the second fastening element is not bulged outward by threading force of the fastening screw 13, and the probability of the fastening screw 13 to be loosened in the lens fastening device is decreased.

Next, in the lens fastening device according to the second embodiment of the present invention as shown in FIG. 4, the flange element 4 is prepared separately from the fastening element which has the guide part 3 and body part 1 integrally formed with each other. The flange element 4 is made of metal or hard synthetic resin. The flange element 4 is fitted into the circumferential fitting groove 5 defined on the outer surface of the body part 1 of the fastening element. The lens fastening device assembled in this way can firmly and easily fasten the lens 12 to each of the bridge 10 and the arm 11.

Due to the fact that the body part 1 and the guide part 3 are integrally formed with each other and made of synthetic resin, and the flange element 4 made of metal or hard synthetic resin is fitted into the circumferential fitting groove 5 defined on the outer surface of the body part 1, the fastening screw 13 can be firmly threaded through the guide part 3 and the body part 1. Also, due to the presence of the flange element 4 made of metal or hard synthetic resin, the body part 1 and the guide part 3 are prevented from being excessively softened or hardened due to temperature changes. Further, fastening force is not diminished between the lens 12 and each of the bridge 10 and the arm 11, and the fastening screw 13 is prevented from being unintentionally unthreaded or loosened.

In other words, in the case that a temperature rises, because the body part 1 is prevented from being enlarged in its outer diameter by the flange element made of metal or hard synthetic resin, the body part 1 and the guide part 3 are kept from being softened. In the case that a temperature falls, the flange element 4 made of metal or hard synthetic resin prevents an axial length of the circumferential fitting groove 5 defined on the outer surface of the body part 1 from being shortened, whereby dimension change can be suppressed to the maximum.

As apparent from the above description, the lens fastening device for frameless spectacles according to the present invention provides advantages in that, since a first fastening element having a guide part is made of soft synthetic resin, a gap is eliminated between a lens and a screw threaded through the first fastening element, whereby it is possible to prevent the lens from being fluctuated and the screw from being unintentionally unthreaded. Also, because a second fastening element having a flange part is made of metal or hard synthetic resin, strong fastening force is provided while the flange part squeezes the lens against each of a bridge or an arm. Further, due to the presence of the flange part serving as a fastening cap, made of metal or hard synthetic resin scarcely influenced by a weather condition, fastening force is not diminished even in hot summer weather or in cold winter weather. Moreover, due to the fact that the first fastening element can be easily inserted into the hole defined in the lens and the second fastening element can be easily coupled-to the first fastening element, assemblability and productivity are improved.

In the drawings and specification, there have been disclosed typical preferred embodiments of the invention and, although specific terms are employed, they are used in a generic and descriptive sense only and not for purposes of limitation, the scope of the invention being set forth in the following claims.

I claim:

1. A lens fastening device for frameless spectacles, comprising:
a first fastening element made of soft synthetic resin, possessing a guide part formed at a lower end thereof, defined with a threaded hole, and having a tapered part to be decreased in its diameter toward an upper end thereof; and
a second-fastening element prepared separately from and coupled to the -first fastening element, made of metal or hard synthetic resin, possessing a flange part formed on an outer surface and at an upper end thereof, defined with a threaded groove and an engagement groove into which the guide part of the first fastening element is engaged, and having a body part.

2. The lens fastening device as set forth in claim 1, wherein an insertion groove having an inner diameter, which is the same as an outer diameter of the guide part, is defined on an inner surface defining the threaded groove and adjacent to the upper end of the second fastening element; the engagement groove is defined on another inner surface defining the insertion groove; and an engagement projection is formed on an outer surface of the guide part of the first fastening element, whereby the guide part is inserted into the insertion groove and the engagement projection is engaged into the engagement groove.

3. A lens fasten device frameless spectacles, comprising:
a fastening element having a guide part and a body part which are integrally formed with each other, the guide part being inserted into a hole which is defined through a lens, the body part being defined on an outer surface thereof with a circumferential fitting groove; and
a flange element fitted into the circumferential fitting groove and made of metal or hard synthetic resin.
